(19) United States
(12) Patent Application Publication
(10) Pub. No.: US 2013/0136283 A1
(43) Pub. Date: May 30, 2013

(54) HEARING INSTRUMENT

(71) Applicants: Jacob Alexander de Ru, Zeist (NL); Willem Christiaan Heerens, Rijswijk (NL)

(72) Inventors: Jacob Alexander de Ru, Zeist (NL); Willem Christiaan Heerens, Rijswijk (NL)

(73) Assignee: AUDIUNT HOLDING B.V., Zeist (NL)

(21) Appl. No.: 13/579,112

(22) PCT Filed: Feb. 22, 2011
(86) PCT No.: PCT/NL11/50125

§ 371 Date: Feb. 14, 2013

(30) Foreign Application Priority Data
Feb. 24, 2010 (NL) 2004294

(51) Int. Cl. H04R 25/00

(52) U.S. Cl. CPC H04R 25/50
USPC 381/320

(57) ABSTRACT

A method for transforming a sound signal into a signal capable of compensating for the hearing loss of a hearing impaired person using a hearing instrument with a receiver, a processing unit and a transmitter, includes the following steps: a) receiving an input signal by the receiver, the input signal being representative for a sound signal; b) processing the received signal by the processing unit, the processing including the step of filtering; and c) providing the processed signal by the transmitter; where the processing further includes the step of squaring the received signal, the filtering taking place on the squared signal.

### CROSS-REFERENCE TO RELATED APPLICATIONS

This application is the National Stage of International Application No. PCT/NL2011/050125, filed Feb. 22, 2011, which claims the benefit of Netherlands Application No. 2004294, filed Feb. 24, 2010, the contents of which is incorporated by reference herein.

### FIELD OF THE INVENTION

The invention relates to a method for transforming a sound signal, and a hearing instrument.

### BACKGROUND OF THE INVENTION

Hearing impairment is widely known to happen to a majority of people and relates to the full or partial inability to detect or perceive at least some frequencies of sound compared to the average sensitivity to sound common among normal hearing people. Hearing impairment may alternatively be referred to as (partial or full) hearing loss.

The causes of hearing impairment may be long-term exposure to environmental noise, genetic, presbyacusis, disease or illness, medications, exposure to ototoxic chemicals, and physical trauma.

In order to compensate for the hearing loss different types of hearing instruments have been developed. One type of hearing instrument transforms a sound signal into an audible signal for the hearing impaired person and provides the transformed signal to the inner ear via the middle ear or via the skull. This type of hearing instrument will be referred to as hearing aids from now on unless specifically stated otherwise. Hearing aids are characterized in that they provide the transformed sound signal to the inner ear in the form of mechanical vibrations, e.g. by a speaker in the ear canal or by a transducer vibrating the skull of a person, said vibrations then travelling to the inner ear to move the perilymph fluid, i.e. a fluid inside the inner ear.

Types of hearing aids commonly used include behind the ear aids, in the ear aids, bone anchored hearing aids, middle-ear-implants, e.g. the vibrant soundbridge, etc. The middle-ear-implant is implanted in the middle ear and causes the middle ear to vibrate, e.g. by mechanically stimulating the stapes which push on the oval window of the inner ear and/or mechanically stimulating the round window.

Another type of hearing instrument transforms a sound signal for the hearing impaired person and provides the transformed sound signal directly to the nerves in the scala tympani using electrodes. This type of hearing instrument will be referred to as cochlear implant from now on unless specifically stated otherwise. A cochlear implant is characterized in that it provides the transformed sound signal to the inner ear in an electrical form by directly stimulating the auditory nerves, which is different from the hearing aids using mechanical vibrations to transmit the sound signal. This type of hearing instrument also includes devices which indirectly stimulate the auditory nerves, e.g. via brain stem stimulation.

A disadvantage of current hearing instruments is that they are not able to fully compensate for the hearing loss. In order to solve this problem more filters and/or more complex filters have been used to properly adjust the sound signal. So far, these attempts have been unsatisfactory.

### SUMMARY OF THE INVENTION

It is therefore an object of the invention to provide an improved hearing instrument.

This object is achieved by providing a method for transforming a sound signal into a signal capable of compensating for the hearing loss of a hearing impaired person using a hearing instrument with a receiver, a processing unit and a transmitter, said method comprising the following steps:
a) receiving an input signal by the receiver, said input signal being representative for a sound signal;
b) processing the received signal by the processing unit, said processing comprising the step of filtering; and
c) providing the processed signal by the transmitter;
   characterized in that the processing further comprises the step of squaring the received signal, the filtering taking place on the squared signal.

The filtering is based on an audiogram of the hearing impaired person—said audiogram being the hearing loss of the hearing impaired person as a function of frequency—to compensate for the hearing loss.

In this description, squaring of a signal refers to the multiplication of the signal with itself, i.e. squaring means performing a quadratic mathematical function with the signal as input. It is therefore explicitly mentioned here that squaring in this context does not mean providing a square, i.e. block shaped, wave based on the signal.

The processed signal is based on the filtered signal. As the filtering takes place on the squared signal, the processed signal is also based on the squared signal. This is different from already known methods, such as disclosed in for instance U.S. Pat. No. 6,370,255, in which the received signal is split into two or more signals and one of the signals is squared in order to get a signal representative for the power of the received signal, which squared signal is subsequently used to manipulate another one of the signals, e.g. adjusting the amplitude of the signal in dependency of the power of the received signal. It is the manipulated received signal which forms the basis for the signal transmitted to the hearing impaired person and not the squared signal itself, so that U.S. Pat. No. 6,370,255 does not disclose that the processed signal which is transmitted to the hearing impaired person is based on the squared signal itself.

The invention is based on the insight that squaring of the signal also occurs inside the human ear, so that full compensation of hearing loss can only be reached when the hearing instrument takes account of this natural working principle of the human ear, which will be illustrated below.

The working principle of the cochlea in the inner ear is up till now based on the work of Von Bekesy. In Von Bekesy's theory, sound pressure variations in front of the eardrum—transferred by the ossicular chain—evoke pressure waves inside the cochlea. These pressure waves set the basilar membrane into a travelling wave motion running from the base, nearby the oval window, to the apex or helicotrema. It is generally believed that this travelling wave transfer mechanism generates a maximum deflection at a specific location on the basilar membrane and then extinguishes rapidly thereafter in the direction of the helicotrema. The deflection then evokes an electric signal in the organ of Corti, which is transferred to the auditory cortex via the auditory nerve. In this theory, the frequency content of the electric signals generated in the cochlea is always similar to the frequency content of the sound signals responsible for the electric signals. As current hearing instruments are based on this theory, they simply filter the frequency content of the received sound signal.

After elaborate modelling of the physics of the cochlea and verifying the model in a number of sound experiments, the applicant is of the opinion that the current theory is not representative for the working principle of the human ear and has formed a new theory for the cochlea, which allows for a much more satisfactory explanation of anomalous results from past experiments and also provides explanations for phenomena which were not available before. The new theory is based on the applicant's insight that the sound pressure variations in front of the eardrum evoke movement of the perilymph fluid in the cochlea. This transfer of acoustic pressure variations to perilymph velocity means that the incoming signal is differentiated in time. And subsequently, it is the velocity of the perilymph fluid that causes pressure differences on either side of the Reissner membrane and basilar membrane based on Bernoulli's law, which yields:

$$Δ p = - \frac{1}{2} ρ {v}^{2}$$

wherein Δp is the pressure difference, ρ is the density of the perilymph fluid and v is the time dependent velocity of the perilymph fluid. Effectively this means that the sound signal is first differentiated and subsequently squared in the human ear. The pressure differences then set the basilar membrane into motion to stimulate the auditory nerves via the organ of Corti. Here Bernoulli's law is applied under quasi-static conditions which is allowed because the low viscosity and incompressibility of the perilymph fluid and the low Reynolds number during the time dependent movements guarantee the necessary laminar flow conditions.

For a pure tone sound signal, i.e. a sound signal with single frequency, differentiating and squaring results in doubling of the frequency and systematically increasing the signal amplitude by 6 dB/octave, so that the relationship still seems to be linear. As audiograms are made using pure tones, while the 6 dB/octave relationship is also incorporated in the so-called Fletcher-Munson curve—serving as the average reference sensitivity characteristic —, the effects of differentiating and squaring are invisible in the audiogram.

The main difference between the old theory and the new theory can be seen when two tones of different frequency are combined. Suppose that after the differentiation process the velocity of the perilymph fluid is expressed as v=cos(2πf₁t)+cos(2πf₂t), wherein t is time, and f₁ and f₂ are the different frequencies. Due to the squaring effect of the cochlea, the pressure signal on the basilar membrane is:

$$Δ p = - \frac{1}{2} ρ ( {cos}^{2} ( 2 π {f}_{1} t ) + {cos}^{2} ( 2 π {f}_{2} t ) + 2 cos ( 2 π {f}_{1} t ) cos ( 2 π {f}_{2} t ) )$$

which can alternatively be written as:

$$Δ p = - \frac{1}{4} ρ ( 2 + cos ( 2 π {f}_{1} t ) + cos ( 2 π {f}_{2} t ) + 2 cos ( 2 π ( {f}_{1} - {f}_{2} ) t ) + 2 cos ( 2 π ( {f}_{1} + {f}_{2} ) t ) )$$

From the above equation it follows that by squaring the signal, not only the original frequencies are doubled, but the signal also comprises a component having a frequency equal to the sum of the two original frequencies and a component having a frequency equal to the difference between the two original frequencies. The frequency content perceived by the inner ear's organ of Corti is thus not equal to the frequency content of the sound signal itself.

By adjusting the amplitude of the sound signal in one frequency range, as is done in current hearing instruments, also adjustment of the “added” components having the sum frequency and the difference frequency occurs. As usually these components are in different frequency ranges having different hearing loss, adjustment of the amplitude in one frequency range may worsen the sound signal in another frequency range.

The effect is even worse when the sound signal contains more different frequencies. As an example, a sound wave consisting of 100 individual enharmonic components each having a different frequency results in the generation of about 10,000 frequency signals in the human ear due to the squaring effect.

Because the pressure stimulus on the basilar membrane is proportional to the vibration energy of the perilymph fluid, the new theory can be formulated as that the human ear detects and transfers the power spectrum density of the sound signal, where the old theory assumes that the human ear detects the frequency spectrum of the sound signal itself.

By squaring the signal in the method according to the invention, the “extra” components are created similar to the human ear, and by subsequently filtering the squared signal, the filtering is done in a more effective way, so that a better compensation of the hearing loss can be achieved with less and/or less complex filters.

The invention is in particular suitable for hearing impaired persons, but may also be used in environments where protection to sounds is required, especially when only a certain frequency range needs to be attenuated and other frequencies may not. It is further mentioned here that the method in a preferred embodiment is applied to a hearing instrument which in use is provided on or in the human body, in particular in the head region, more particularly in the ear region of the human body. A more detailed description of such a hearing instrument will be provided below.

In an embodiment, the processing further comprises the step of taking the square root of the filtered signal. This step may be important for hearing aids which have to provide mechanical vibrations to the human ear, wherein the mechanical vibrations have to represent a sound signal again and not a power signal. In case of a cochlear implant, taking the square root is not necessary as the cochlear implant is taking over the function of the inner ear and directly applies the filtered signal to the auditory nerves, which based on the new theory normally receive a squared signal, i.e. a power signal.

Squaring and subsequently taking the square root of the signal may effectively result in taking the absolute value of the signal, so that due to these steps information about the polarity of the original signal may be lost. In that case, the hearing instrument is not able to properly create a sound signal that can be transmitted to the inner ear of a hearing impaired person. Therefore, taking the square root of the filtered signal preferably includes restoring the polarity of the signal based on the polarity of the received signal. An example of restoring the polarity may be:
capturing polarity information from the received signal by producing a square wave signal therefrom, said square wave signal having crossovers corresponding to zero crossings of the received signal, and preferably said square wave signal having an amplitude of one unit;
taking the square root of the filtered signal and multiplying the square root of the filtered signal with the square wave signal containing the polarity information, thereby restoring the polarity information lost due to the squaring and taking of the square root.

In an embodiment, the processing further comprises the step of differentiating the received signal, so that squaring takes place on the differentiated signal. Because the inner ear responds to the velocity of the perilymph fluid, a differentiating action has taken place from displacement of the tympanic membrane or skull to the velocity of the perilymph fluid. An advantage of differentiating may be that our inner ear has adjusted itself to the so-called 1/f relation for sounds found in nature, which means that the sound pressure amplitude of a pure tone in a tone complex will be reciprocal to its frequency. By differentiating a sound having such a 1/f relation, the signal strength of each tone at the basilar membrane becomes frequency-independent. By adding this operation to the method, the same advantage can be gained, so that the signal to noise ratio in the frequency range of interest is more or less frequency-independent, and filtering can be done in a more convenient way.

When the method is used in hearing aids, the opposite operation of differentiating, i.e. integrating is preferably also part of the processing, so that the filtered signal, or the square root of the filtered signal if applicable, is integrated to restore the original 1/f relationship and apply an appropriate signal to the hearing impaired person. For cochlear implants, this integrating operation may be omitted.

As mentioned before, the filtering may be based on the audiogram of the hearing impaired person, wherein said audiogram is the hearing loss as function of frequency, to compensate for the hearing loss. Hearing loss is generally expressed in terms of threshold of hearing relative to a standardised curve that represents “normal” hearing, normally in dBHL. Popularly said, an audiogram represents the amplification required for the hearing impaired person to experience a sound signal at the same intensity level as the reference person, having the ideal average audiogram given by the Fletcher-Munson curve. By using the audiogram as a basis to set the filtering action, the hearing loss in principle can be fully compensated, although the actual compensation may also depend on other parameters such as type of hearing impairment, i.e. the actual cause of the hearing impairment.

In most cases, hearing loss is frequency dependent, so that applying an overall amplification factor to the frequency range of interest will not fully compensate the hearing loss. The filtering may therefore comprise the steps of adjusting the amplitude of the squared signal in a predetermined frequency range with a frequency-dependent value composed of a frequency-independent component and a frequency-dependent component (in equation form: V(f)=c1*c2(f), wherein V is the frequency-dependent value, f is the frequency, c1 is the frequency-independent component and c2 is the frequency-dependent component).

By adjusting or setting the frequency-independent component, which is equal over the entire frequency range, the overall amplification of the signal, i.e. the intensity of the signal, can be controlled, whereas the frequency-dependent component can be adjusted to the hearing loss of the hearing impaired person. Preferably, the frequency-dependent component is based on the audiogram of the hearing impaired person, and the frequency-independent component is based on the audiogram and the mean value of the squared signal prior to filtering. As the squared signal represents a power signal, the mean value is a good reference for the overall intensity of the signal. By adjusting the frequency-independent component of the filter to this mean value and to the audiogram of the person, the optimal amplification of the signal can be set for the hearing impaired person. For instance, it can be adjusted such that the intensity of the transmitted signal is below a certain predetermined maximum value, e.g. the threshold of pain.

When the bandwidth of the squaring and/or differentiating operations are larger than the maximum frequency audible for a normal person, which is about 20 kHz, a lot of noise may be introduced which is not desired. To avoid the entrance of this noise, the received signal may be low-pass filtered prior to processing.

Processing of the received signal preferably takes place in the frequency range of about 20 Hz-20 kHz being the audible range for normal hearing, but the processing may also be limited to the frequency range of 100 Hz-8 kHz as being the most important for a clear understanding of speech. The frequency range may be set by the processing itself, but may also be set by low-pass or band-pass filtering the received signal prior to processing.

The present invention also relates to a hearing instrument to compensate the hearing loss of a hearing impaired person, comprising:
a receiver for receiving an input signal being representative for a sound signal;
a processing unit to process the received signal, said processing unit being configured to process the received signal by filtering; and
a transmitter to transmit the processed signal,
   characterized in that the processing unit is further configured to square the received signal, so that filtering takes place on the squared signal.

The filtering is based on an audiogram of the hearing impaired person—said audiogram being the hearing loss of the hearing impaired person as a function of frequency—to compensate for the hearing loss.

The processed signal is based on the filtered signal. As the filtering takes place on the squared signal, the transmitted processed signal is based on the squared signal. Squaring of the received signal is thus done in the main branch from receiver to transmitter and not only in a side branch of the circuit, wherein said side branch is configured to manipulate the main branch as e.g. disclosed in U.S. Pat. No. 6,370,255.

As described for the method according to the invention, the hearing instrument is now able to more closely represent the working of the human inner ear and thus able to more closely compensate for the hearing loss by filtering the squared signal instead of the signal itself.

In an embodiment, the processing unit is configured to take the square root of the filtered signal, thereby enabling a hearing aid to output a proper sound signal to the hearing impaired person. Preferably, the processing unit is configured to restore the polarity of the signal based on the polarity of the received signal when taking the square root of the filtered signal. The processing unit may therefore capture polarity information from the received signal.

In an embodiment, the processing unit is configured to differentiate the received signal, so that squaring takes place on the differentiated signal. The advantage is that sound showing a 1/f relationship will after differentiating show a relationship in which the contribution of a signal component to the overall strength of the signal is frequency-independent. If a processing unit is also configured to differentiate, the earlier mentioned capturing of polarity information preferably takes place on the differentiated signal.

In an embodiment, the processing unit is configured to integrate the filtered signal or integrate the square root of the filtered signal if applicable. In this way, hearing aids according to the invention and configured to differentiate the received signal are able to output a proper sound signal to the hearing impaired person.

In an embodiment, the processing unit is configured to filter the squared signal by adjusting the amplitude of the squared signal in a predetermined frequency range with a frequency-dependent value composed of a frequency-independent component and a frequency-dependent component. The frequency-dependent component is preferably based on the audiogram of the hearing impaired person and the frequency-independent component is preferably based on the audiogram of the hearing impaired person and the mean value of the squared signal prior to filtering.

The hearing instrument may be a hearing aid configured to be worn on or into the human body. Alternatively, the hearing instrument may be a cochlear implant. In other words, the hearing instrument is suitable to be provided in use on or in the human body, in particular the head region of the body and more particularly the ear region of the human body.

In an embodiment, the receiver is configured to low-pass filter the input signal.

The invention also relates to the use of a hearing instrument as described above on or into a human body of a hearing impaired person to compensate for hearing loss.

The invention also relates to a method of determining the audiogram of a user using a hearing instrument according to the invention, wherein the hearing instrument comprises a communication module for communication between the hearing instrument and a user interface, e.g. a computer, wherein the communication module is able to input test signals to the hearing instrument that can be transmitted to the user via at least the transmitter, and wherein the communication module is able to communicate with the processing unit of the hearing instrument to adapt and also possibly to read the filter settings, said method comprising the following steps:
i) applying a test signal to the user, said test signal having a predetermined amplitude at a first frequency;
ii) awaiting a response of the user via the interface;
iii) in case no response is given the first time within a predetermined time frame, increasing the amplitude of the test signal and performing the steps i) and ii) again until a response is given by the user via the interface, and in case a response is given the first time within the predetermined time frame, decreasing the amplitude of the test signal and performing the steps i) and ii) again until no response is given;
iv) determining the threshold for hearing at the first frequency as part of the audiogram;
v) if applicable, repeating the steps i)-iv) for other frequencies until a predetermined frequency range is covered and a complete audiogram is determined.

After the audiogram is completely determined, the filter settings of the hearing instrument can be adjusted via or by the communication module to compensate for the differences in hearing of the user with regard to the Fletcher Munson curve representing the average hearing capabilities of humans. The filter settings may be calculated from the measurement data by the interface and subsequently communicated to the hearing instrument via the communication module or may be calculated by the communication module itself.

The communication module may communicate wirelessly with the interface, but may also be connected to the interface via a wire, wherein said wire may be temporarily connected to the hearing instrument and/or interface for carrying out the method.

The interface may store the audiogram, preferably including the date on which the audiogram was measured, each time an audiogram is measured, so that different audiograms can be compared with each other e.g. to determine whether the hearing loss is deteriorating.

### BRIEF DESCRIPTION OF THE DRAWINGS

The invention will now be described in a non-limiting way with reference to the accompanied drawings, in which like reference symbols designate like parts.

FIG. 1 shows a highly schematic representation of a hearing instrument according to an embodiment of the invention;

FIG. 2 shows in more detail an embodiment of a processing unit suitable for the hearing instrument of FIG. 1;

FIG. 3 shows in more detail another embodiment of a processing unit suitable for the hearing instrument of FIG. 1;

FIG. 4 shows in more detail yet another embodiment of a processing unit suitable for the hearing instrument of FIG. 1;

FIG. 5 shows in more detail an embodiment of a receiver and processing unit suitable for the hearing instrument of FIG. 1;

FIG. 6 shows a highly schematic representation of a hearing instrument according to another embodiment of the invention.

### DETAILED DESCRIPTION OF THE INVENTION

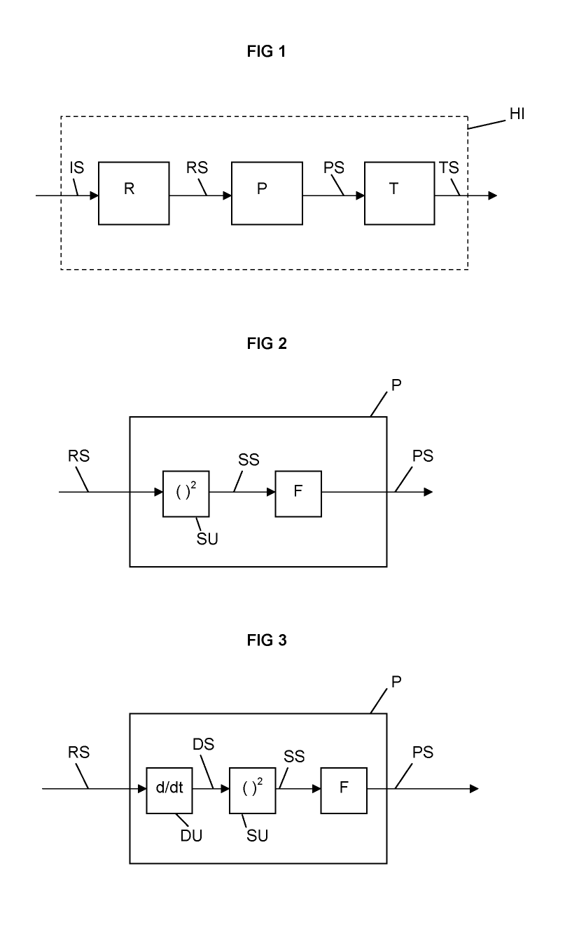

FIG. 1 shows a schematic representation of a hearing instrument HI for a hearing impaired person according to the invention. The hearing instrument HI comprises a receiver R for receiving an input signal IS being representative for a sound signal. This does not exclude that the input signal IS is the sound signal itself, i.e. consists of acoustic vibrations. The receiver may in that case be a microphone converting the sound signal into an electric signal. The input signal may also be an electromagnetic signal. In that case, the receiver may be a coil, e.g. a T-coil, converting the electromagnetic signal into an electric signal. The output of the receiver is referred to as received signal RS.

The hearing instrument HI also comprises a processing unit P to process the received signal RS, and a transmitter T to transmit the processed signal PS to the hearing impaired person. The signal received by the hearing impaired person is the transmitted signal TS. The transmitter may be a device, such as a speaker or other transducer, converting an electric signal into a mechanical or acoustical vibration signal in case of a hearing aid, but may also output an electric signal in case of a cochlear implant.

The processing unit is configured to process the received signal RS by filtering. The processing unit is further configured to square the received signal, so that filtering takes place on the squared signal. The processed signal is based on the filtered signal as will be shown below. By squaring the received signal, an important part of the working principle of the human ear is mimicked by the processing unit. Preferably, the hearing instrument also mimics the differentiating action of the human ear, either by differentiating during converting signals in the receiver R, which can be done automatically due to the nature of the receiver, or by a separate differentiating action in the processing unit as will be explained below.

A simple embodiment of a processing unit P is shown in more detail in FIG. 2. Said processing unit P is suitable to be used in the hearing instrument of FIG. 1, in particular a cochlear implant. The processing unit comprises a squaring unit SU and a filter F. The squaring unit SU is configured to square a received signal RS. The received signal RS is a signal coming from a receiver as shown in FIG. 1.

The output of the squaring unit SU is a squared signal SS that is provided to the filter F. The output of the filter F is a processed signal PS, which can be provided to a transmitter T as shown in FIG. 1.

Another embodiment of a processing unit P is shown in more detail in FIG. 3. The processing unit P is suitable to be used in the hearing instrument of FIG. 1, especially when the hearing instrument is a cochlear implant. Input to the processing unit P is a received signal RS, which is received by a receiver similar to the embodiment shown in FIG. 1. The processing unit comprises a differentiating unit DU configured to differentiate the received signal RS. The output of the differentiating unit DU is referred to as the differentiated signal DS. The differentiated signal DS is supplied to a squaring unit SU which squares the differentiated signal DS. The output of the squaring unit SU is referred to as the squared signal SS. The squared signal in turn is supplied to a filter F which filters the squared signal. Here, the output of the filter F is at the same time the output of the processing unit and is referred to as the processed signal PS. Said processed signal PS may be provided to a transmitter T as shown in FIG. 1.

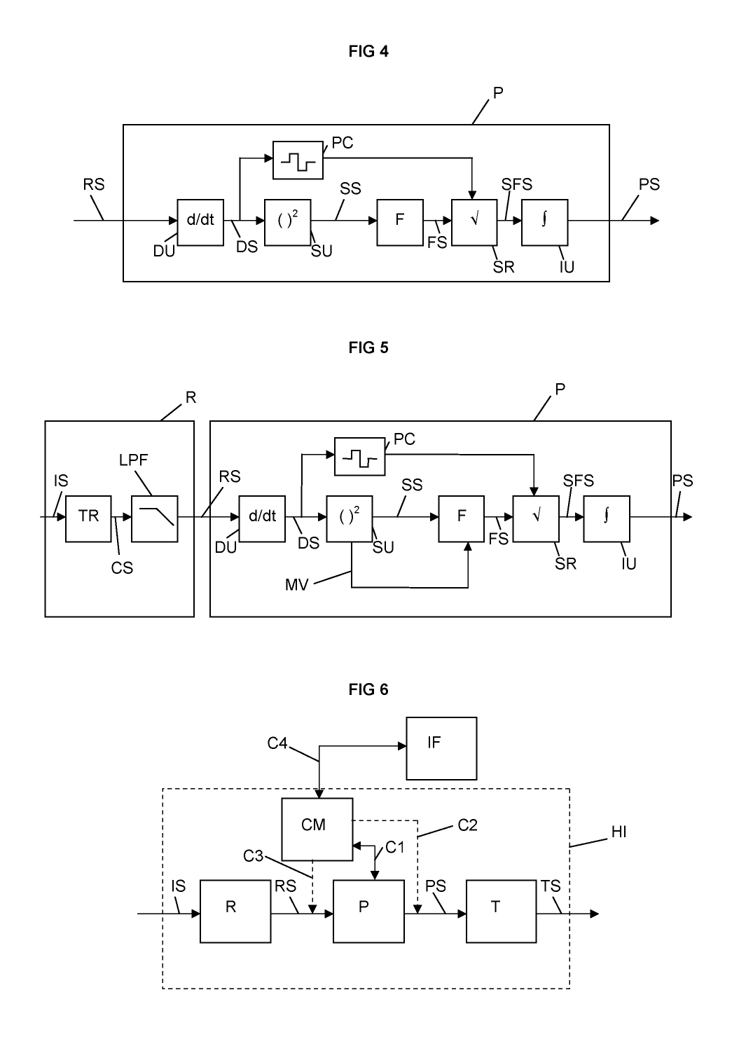

FIG. 4 shows yet another embodiment of a processing unit P which is suitable for a hearing instrument according to FIG. 1, in particular for a hearing aid. Input to the processing unit P is a received signal RS received by a receiver as shown in FIG. 1. The received signal is provided to a differentiating unit DU which is configured to differentiate the received signal. The output of the differentiating unit is referred to as differentiated signal DS. The differentiated signal DS is squared by a squaring unit SU, and is provided to a polarity capturer PC which captures the polarity information of the differentiated signal, e.g. by producing a square wave signal from the differentiated signal DS, wherein said square wave signal has crossovers corresponding to the zero crossings of the differentiated signal, and wherein said square wave signal preferably has an amplitude of one unit. The output of the squaring unit SU is referred to as squared signal SS and is supplied to a filter F. The output of the filter F is referred to as the filtered signal FS and is supplied to a square root unit SR configured to take the square root of the filtered signal.

The square root unit SR is further configured to restore the polarity of the signal based on the polarity of the received signal when taking the square root of the filtered signal. The square root unit SR therefore uses the output of the polarity capturer PC containing the polarity information. The output of the square root unit SR is referred to as the square root of the filtered signal SFS and is supplied to an integrating unit IU configured to integrate the square root of the filtered signal SFS. The output of the integrating unit is the output of the processing unit and is referred to as processed signal PS. The processed signal PS is supplied to a transmitter as shown in FIG. 1.

FIG. 5 shows in more detail an embodiment of a receiver R and a processing unit P which are suitable to be used in a hearing instrument according to FIG. 1, especially in a hearing aid.

The processing unit P is similar to the processing unit of FIG. 4 and comprises a differentiating unit DU, a squaring unit SU, a polarity capturer PC, a filter F, a square root unit SR and an integrating unit IU. The difference between the embodiments of FIGS. 4 and 5 is that in the embodiment of FIG. 5 the squaring unit has a second output MV corresponding to the mean value of the squared signal SS. This output MV is provided to the filter F as an input. The filter F is configured to adjust the filter properties in dependency of the mean value MV. Preferably, the filter F adjusts the overall amplification, i.e. the frequency-independent component of the amplification value of the filter F based on the mean value MV.

In FIG. 5, the receiver R comprises a transducer TR and a low-pass filter LPF. The transducer converts the input signal into a converted signal CS, usually an electric signal, and the low-pass filter is configured to low-pass filter the converted signal CS. The output of the low-pass filter is provided to the processing unit as input, i.e. the received signal RS.

FIG. 6 depicts a highly schematic representation of a hearing instrument HI according to another embodiment of the invention. The hearing instrument HI comprises a receiver R for receiving an input signal IS being representative for a sound signal. The receiver may be a microphone or a T-coil as mentioned for the embodiment according to FIG. 1. The output of the receiver R is referred to as received signal RS.

The hearing instrument HI also comprises a processing unit to process the received signal RS, and a transmitter T to transmit the processed signal PS to a hearing impaired person. The signal received by the hearing impaired person is the transmitted signal TS. The transmitter may be a device, such as a speaker or other transducer, converting an electric signal into a mechanical or acoustical vibration signal in case of a hearing aid, but may also output an electric signal in case of a cochlear implant.

The processing unit is configured to process the received signal RS by filtering. The processing unit is further configured to square the received signal, so that filtering takes place on the squared signal, e.g. as described in relation to the embodiments of FIGS. 2-5.

The hearing instrument further comprises a communication module CM for communication between an external interface IF and the hearing instrument as indicated by communication line C4. The communication line C4 may in practice be a wireless link, via e.g. infrared, Bluetooth or any other wireless protocol or principle, but may also be a conventional wire that is provided between the hearing instrument and the interface IF, wherein said wire may also be temporarily provided, so only when communication is required.

The communication module may allow only one-way communication, so from interface to hearing instrument only, but may also allow two-way communication as indicated in FIG. 6. The communication module internally communicates with the processing unit P—as indicated by communication line C1—to adapt the filter settings of the filter used in the processing unit. The interface may be used to input the desired filter settings, or a measured audiogram may be inputted so that the interface or communication module is able to determine the desired filter settings therefrom. The communication module may further be configured to read the current filter settings from the processing unit and communicate them to the interface.

The communication module also allows to measure the audiogram of a user using the hearing instrument itself. The communication module therefore is configured to input test signals into the path leading to the transmitter T of the hearing instrument. To input the test signals, communication line C1 may be used so that the test signals are inputted to the processing unit. Alternatively or additionally, the test signals can be inputted anywhere in the signal path between receiver and transmitter as indicated by dashed communication lines C2 and C3.

The hearing instrument according to FIG. 6 allows to perform the following method of determining the audiogram of a user:
i) applying a test signal to the user, said test signal having a predetermined amplitude at a first frequency;
ii) awaiting a response of the user via the interface;
iii) in case no response is given the first time within a predetermined time frame, increasing the amplitude of the test signal and performing the steps i) and ii) again until a response is given by the user via the interface, and in case a response is given the first time within the predetermined time frame, decreasing the amplitude of the test signal and performing the steps i) and ii) again until no response is given;
iv) determining the threshold for hearing at the first frequency as part of the audiogram;
v) if applicable, repeating the steps i)-iv) for other frequencies until a predetermined frequency range is covered and a complete audiogram is determined.

The initial amplitude of a test signal transmitted to the user is preferably the amplitude corresponding to the Fletcher Munson curve at that frequency.

Based on the measured audiogram, the filter settings may be adapted by the communication module.

The interface IF is preferably a computer device able to interact with the user so that the method can be started and stopped and a response to a test signal can be given. The measured audiograms may be stored on the interface for analytical purposes.

It is explicitly mentioned here that some or all of the features or functions of the processing units shown in the drawings and further described here and in the claims may be implemented in hardware, but may also be implemented in software, for instance as processing instructions stored in a memory and run on a microprocessor. The processing instructions being arranged for having the microprocessor perform at least part of the stated functions of the processing unit. The processing unit may therefore comprise an analog-to-digital convertor and a digital-to-analog convertor so that the processing instructions are carried out in the digital domain.

In case the implementation is at least partially done in hardware, the processing unit may comprise circuits, such as a differentiating, squaring and/or integrating circuit e.g. composed of hardware components such as operational amplifiers, capacitors, resistors and/or inductors.

The filters in the shown embodiments are preferably configured to filter based on an audiogram of the hearing impaired person, wherein the audiogram is the hearing loss of the hearing impaired person as a function of frequency, to compensate for the hearing loss. The audiogram may be stored in a memory and form the basis for the filter, i.e. the filters use the information of the audiogram in the memory as an input. Adjusting the audiogram, for instance by uploading to the memory and overwriting the existing audiogram, may adapt the hearing instrument to a person in case the hearing loss is changing over time.

The receiver, processing unit and transmitter shown in the different embodiments may be housed inside a housing that in use is worn on or into the human body. Said housing may comprise two parts, wherein one part for instance comprises the receiver and processing unit, and another part comprises the transmitter, and wherein the two parts are interconnected by a wire or the like to allow communication between the two parts. In an embodiment, the communication may also be wireless.

The invention may be summarized by the following clauses:

1. A method for transforming a sound signal into an audible signal e.g. for a hearing impaired person, comprising the following steps:
a) receiving an input signal being representative for a sound signal;
b) processing the received signal, said processing comprising the step of filtering; and
c) transmitting the processed signal, preferably to the hearing impaired person;
characterized in that the processing further comprises the step of squaring the received signal, the filtering taking place on the squared signal.

2. A method according to clause 1, wherein processing further comprises the step of taking the square root of the filtered signal.

3. A method according to clause 2, wherein taking the square root of the filtered signal includes restoring the polarity of the signal based on the polarity of the received signal.

4. A method according to any of the clauses 1-3, wherein processing further comprises the step of differentiating the received signal, the squaring taking place on the differentiated signal.

5. A method according to clause 4, wherein processing further comprises the step of integrating the filtered signal or integrating the square root of the filtered signal if applicable.

6. A method according to any of the preceding clauses, wherein filtering is based on an audiogram of the hearing impaired person, said audiogram being the hearing loss of the hearing impaired person as a function of frequency, to compensate for the hearing loss.

7. A method according to any of the preceding clauses, wherein filtering comprises the steps of adjusting the amplitude of the squared signal in a predetermined frequency range with a frequency-dependent value composed of a frequency-independent component and a frequency-dependent component.

8. A method according to clause 7, wherein the frequency-dependent component is based on the audiogram of the hearing impaired person and the frequency-independent component is based on the audiogram of the hearing impaired person and the mean value of the squared signal prior to filtering.

9. A method according to any of the preceding clauses, wherein the received signal is low-pass filtered prior to processing.

10. A hearing instrument, e.g. for a hearing impaired person, comprising:
a receiver for receiving an input signal being representative for a sound signal;
a processing unit to process the received signal, said processing unit being configured to process the received signal by filtering; and
a transmitter to transmit the processed signal, preferably to the hearing impaired person;
characterized in that the processing unit is further configured to square the received signal, so that the filtering takes place on the squared signal.

11. A hearing instrument according to clause 10, wherein the processing unit is configured to take the square root of the filtered signal.

12. A hearing instrument according to clause 11, wherein the processing unit is configured to restore the polarity of the signal based on the polarity of the received signal when taking the square root of the filtered signal.

13. A hearing instrument according to any of the clauses 10-12, wherein the processing unit is configured to differentiate the received signal, so that squaring takes place on the differentiated signal.

14. A hearing instrument according to clause 13, wherein the processing unit is configured to integrate the filtered signal or integrate the square root of the filtered signal if applicable.

15. A hearing instrument according to any of the clauses 10-14, wherein the processing unit is configured to filter the squared signal based on an audiogram of the hearing impaired person, said audiogram being the hearing loss of the hearing impaired person as a function of frequency, to compensate for the hearing loss.

16. A hearing instrument according to any of the clauses 10-15, wherein the processing unit is configured to filter the squared signal by adjusting the amplitude of the squared signal in a predetermined frequency range with a frequency-dependent value composed of a frequency-independent component and a frequency-dependent component.

17. A hearing instrument according to clause 16, wherein the frequency-dependent component is based on the audiogram of the hearing impaired person and the frequency-independent component is based on the audiogram of the hearing impaired person and the mean value of the squared signal prior to filtering.

18. A hearing instrument according to any of the clauses 10-17, wherein the hearing instrument is a hearing aid configured to be worn on or into the human body.

19. A hearing instrument according to any of the clauses 10-17, wherein the hearing instrument is a cochlear implant.

20. A hearing instrument according to any of the clauses 10-19, wherein the receiver is configured to low-pass filter the input signal.

21. The use of a hearing instrument according to any of the clauses 10-20.

22. A method according to one or more of the clauses 1-9 performed using a hearing instrument according to one or more of the clauses 10-20.
